(19) United States
(12) Patent Application Publication
(10) Pub. No.: US 2012/0151948 A1
(43) Pub. Date: Jun. 21, 2012

(54) REFRIGERATION CYCLE APPARATUS

(75) Inventors: Takeshi Ogata, Osaka (JP); Hiroshi Hasegawa, Osaka (JP)

(73) Assignee: PANASONIC CORPORATION, Kadoma-shi, Osaka (JP)

(21) Appl. No.: 13/393,172

(22) PCT Filed: Jun. 21, 2011
(86) PCT No.: PCT/JP2011/003535

§ 371 Date: Feb. 28, 2012

(30) Foreign Application Priority Data
Jun. 23, 2010 (JP) 2010-143049

(51) Int. Cl. F25B 1/00; G05D 23/32; F25B 41/04

(52) U.S. Cl. 62/157; 62/498; 62/222; 62/190

(57) ABSTRACT

A refrigeration cycle apparatus 100 includes a compressor 2, a radiator 3, a positive displacement fluid machine 4, an evaporator 7, an injection flow passage 10f and a controller 102. The positive displacement fluid machine 4 performs a step of drawing a refrigerant, a step of expanding and overexpanding the drawn refrigerant, a step of supplying, through an injection port 30, the refrigerant to a working chamber so as to mix the supplied refrigerant with the overexpanded refrigerant, a step of recompressing the mixed refrigerant by using power recovered from the refrigerant, and a step of discharging the recompressed refrigerant. The controller 102 executes an activation control for allowing a pressure in the injection flow passage 10f to be a pressure equal to an outlet pressure of the compressor 2 at time of activation of the refrigeration cycle apparatus 100.

### TECHNICAL FIELD

The present invention relates to a refrigeration cycle apparatus.

### BACKGROUND ART

As described in Patent Literature 1, there has been known a refrigeration cycle apparatus including an expander for recovering power from a refrigerant and a sub compressor integrated with the expander. With reference to FIG. 15, the outline of the refrigeration cycle apparatus described in Patent Literature 1 is explained.

As shown in FIG. 15, the refrigeration cycle apparatus 500 described in Patent Literature 1 includes a main compressor 501, a radiator 502, an expander 503, an evaporator 504 and a sub compressor 505. The sub compressor 505 is coupled to the expander 503 by a shaft 506.

A refrigerant is compressed in the main compressor 501 so as to be in a high temperature and high pressure state. The compressed refrigerant is cooled in the radiator 502 and then expanded in the expander 503. The expanded refrigerant changes from a liquid phase to a gaseous phase in the evaporator 504. The gaseous phase refrigerant is compressed from a low pressure to an intermediate pressure in the sub compressor 505 and drawn into the main compressor 501 again.

The sub compressor 505 is driven by the power that the expander 503 has recovered from the refrigerant. Since the sub compressor 505 compresses preliminarily the refrigerant on an upstream of the main compressor 501, the load on a motor 501a of the main compressor 501 is reduced. As a result, the COP (coefficient of performance) of the refrigeration cycle apparatus 500 is enhanced.

### CITATION LIST

### Patent Literature

PTL 1: JP 2004-325019 A

### SUMMARY OF INVENTION

### Technical Problem

The refrigeration cycle apparatus 500 shown in FIG. 15 needs two positive displacement fluid machines, which are the expander 503 and the sub compressor 505. This tends to increase the cost of the refrigeration cycle apparatus 500 to be higher than that of a common refrigeration cycle apparatus in which an expansion valve is used. Moreover, the expander 503 and the sub compressor 505 may not be activated smoothly because they are provided with no motors.

The present invention is intended to provide a power recovery type refrigeration cycle apparatus that can be manufactured at low cost, and a technique for activating the refrigeration cycle apparatus smoothly.

### Solution to Problem

That is, the present invention provides a refrigeration cycle apparatus including:

a compressor for compressing a refrigerant;

a radiator for cooling the refrigerant compressed in the compressor;

a positive displacement fluid machine having a working chamber and an injection port, and configured to perform (i) a step of drawing, at a first pressure, the refrigerant cooled in the radiator into the working chamber, (ii) a step of, in the working chamber, expanding the drawn refrigerant to a second pressure lower than the first pressure and overexpanding further the refrigerant to a third pressure lower than the second pressure, (iii) a step of supplying, through the injection port, the refrigerant having the third pressure to the working chamber so as to mix the supplied refrigerant with the overexpanded refrigerant, (iv) a step of recompressing, in the working chamber, the mixed refrigerant to the second pressure by using power recovered from the refrigerant in the step (ii), and (v) a step of discharging the recompressed refrigerant from the working chamber;

an evaporator for heating the refrigerant discharged from the positive displacement fluid machine;

an injection flow passage through which the refrigerant having the third pressure is supplied to the injection port of the positive displacement fluid machine; and

a controller configured to execute an activation control for allowing a pressure in the injection flow passage to be a pressure equal to an outlet pressure of the compressor, instead of the third pressure, at time of activation of the refrigeration cycle apparatus.

### ADVANTAGEOUS EFFECTS OF INVENTION

According to the refrigeration cycle apparatus of the present invention, the following steps are performed in the positive displacement fluid machine. First, the refrigerant drawn into the working chamber is expanded and overexpanded. Subsequently, the refrigerant having the same pressure as that of the overexpanded refrigerant is injected into the working chamber through the injection flow passage so that the injected refrigerant is mixed with the overexpanded refrigerant in the working chamber. Furthermore, the mixed refrigerant is recompressed by using the power recovered during the expansion and overexpansion of the refrigerant. Since the pressure of the refrigerant can be increased by the recovered power, the load on the compressor is reduced. This improves the COP of the refrigeration cycle apparatus.

Particularly, in the present invention, the steps (ii), (iii) and (iv) are performed as a sequence of steps between a suction process and a discharge process. Thus, in the present invention, unlike in the refrigeration cycle apparatus described in Patent Literature 1, the expander and the sub compressor do not need to be provided independently. Therefore, in the present invention, it is possible to perform each step mentioned above by using the positive displacement fluid machine having a simpler structure. Thereby, the production cost of the refrigeration cycle apparatus can be suppressed.

Furthermore, in the present invention, an activation control for allowing a pressure in the injection flow passage to be a pressure equal to an outlet pressure of the compressor is executed at time of activation of the refrigeration cycle apparatus. When this activation control is executed, the high pressure refrigerant discharged from the compressor is guided to the injection port of the positive displacement fluid machine. This increases the pressure in the working chamber, and thereby the positive displacement fluid machine can be activated easily.

### BRIEF DESCRIPTION OF DRAWINGS

FIG. 1 is a configuration diagram of a refrigeration cycle apparatus according to Embodiment 1 of the present invention.

FIG. 2 is a vertical cross-sectional view of a positive displacement fluid machine used in the refrigeration cycle apparatus shown in FIG. 1.

FIG. 3A is a transverse cross-sectional view of the positive displacement fluid machine shown in FIG. 2, taken along the line X-X.

FIG. 3B is a transverse cross-sectional view of the positive displacement fluid machine shown in FIG. 2, taken along the line Y-Y.

FIG. 4 is a diagram illustrating the operation principle of the positive displacement fluid machine shown in FIG. 2.

FIG. 5 is a graph showing a relationship between the rotation angle of a shaft and the volumetric capacity of a working chamber.

FIG. 6 is a graph showing a relationship between the rotation angle of the shaft and the pressure in the working chamber.

FIG. 7 is a P-V diagram showing a relationship between the pressure in the working chamber and the volumetric capacity of the working chamber.

FIG. 8 is a flow chart illustrating an activation control of the refrigeration cycle apparatus shown in FIG. 1.

FIG. 9 is a configuration diagram of a refrigeration cycle apparatus according to a modification.

FIG. 10 is a flow chart illustrating an activation control of the refrigeration cycle apparatus shown in FIG. 9.

FIG. 11 is a configuration diagram of a refrigeration cycle apparatus according to Embodiment 2 of the present invention.

FIG. 12 is a flow chart illustrating an activation control of the refrigeration cycle apparatus shown in FIG. 11.

FIG. 13 is a flow chart illustrating another activation control of the refrigeration cycle apparatus shown in FIG. 11.

FIG. 14 is a configuration diagram of a refrigeration cycle apparatus according to a modification.

FIG. 15 is a configuration diagram of a conventional refrigeration cycle apparatus.

### DESCRIPTION OF EMBODIMENTS

Hereinafter, embodiments of the present invention are described with reference to the attached drawings. However, the present invention is not limited by the following embodiments. These embodiments can be combined with each other as long as they do not depart from the scope of the present invention.

### Embodiment 1

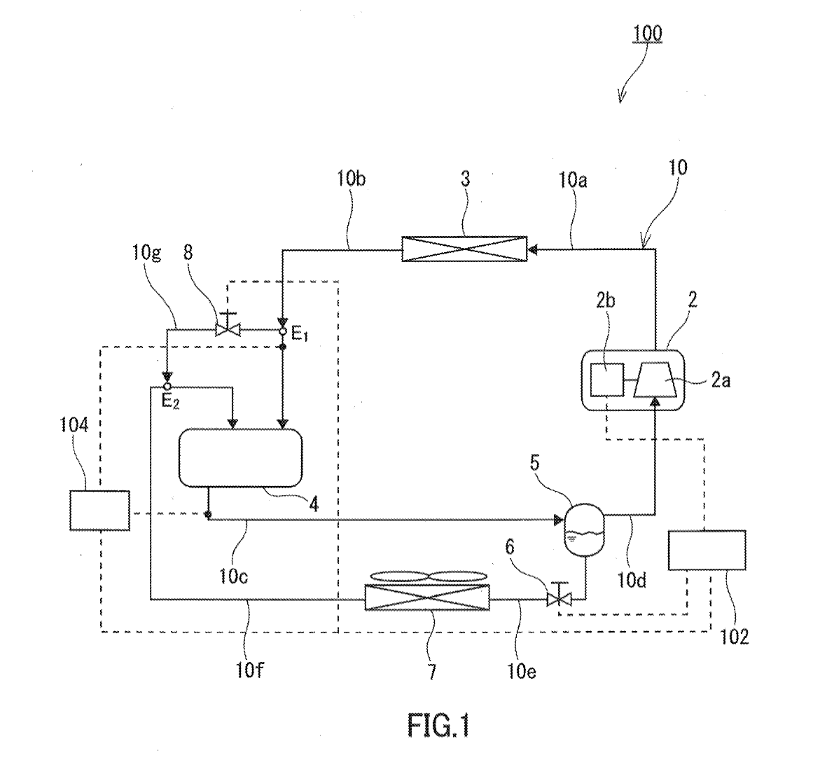

FIG. 1 is a configuration diagram of a refrigeration cycle apparatus according to Embodiment 1. The refrigeration cycle apparatus 100 includes a compressor 2, a radiator 3, a positive displacement fluid machine 4, a gas-liquid separator 5, an expansion valve 6, an evaporator 7 and a bypass valve 8. These components are connected to each other by flow passages 10a to 10g so as to form a refrigerant circuit 10. Typically, the flow passages 10a to 10g each are composed of a refrigerant pipe. The refrigerant circuit 10 is filled with a refrigerant, such as hydrofluorocarbon and carbon dioxide, as a working fluid. The flow passages 10a to 10g may be provided with another component such as an accumulator.

The compressor 2 includes a compression mechanism 2a, and a motor 2b for operating the compression mechanism 2a. The compressor 2 is, for example, a positive displacement compressor such as a rotary compressor and a scroll compressor. The radiator 3 is a device for removing heat from the refrigerant compressed in the compressor 2, and typically is composed of a water-refrigerant heat exchanger or an air-refrigerant heat exchanger. The positive displacement fluid machine 4 has a function of expanding the refrigerant and a function of compressing the refrigerant. The gas-liquid separator 5 is a device for separating the refrigerant discharged from the positive displacement fluid machine 4 into a gas refrigerant and a liquid refrigerant. The gas-liquid separator 5 is provided with a liquid refrigerant outlet, a refrigerant inlet and a gas refrigerant outlet. The expansion valve 6 is a valve with a variable opening, such as an electric expansion valve. The evaporator 7 is a device for providing heat to the liquid refrigerant separated out in the gas-liquid separator 5, and typically is composed of an air-refrigerant heat exchanger.

The flow passage 10a connects the compressor 2 to the radiator 3 so that the refrigerant compressed in the compressor 2 is supplied to the radiator 3. The flow passage 10b connects the radiator 3 to the positive displacement fluid machine 4 so that the refrigerant that has flowed out of the radiator 3 is supplied to the positive displacement fluid machine 4. The flow passage 10c connects the positive displacement fluid machine 4 to the gas-liquid separator 5 so that the refrigerant discharged from the positive displacement fluid machine 4 is supplied to the gas-liquid separator 5. The flow passage 10d connects the gas-liquid separator 5 to the compressor 2 so that the gas refrigerant separated out in the gas-liquid separator 5 is supplied to the compressor 2. The flow passage 10e connects the gas-liquid separator 5 to the evaporator 7 so that the liquid refrigerant separated out in the gas-liquid separator 5 is supplied to the evaporator 7. The flow passage 10f connects the evaporator 7 to the positive displacement fluid machine 4 so that the gas refrigerant that has flowed out of the evaporator 7 is supplied (injected) to the positive displacement fluid machine 4. The cycle explained in this description can be formed of the flow passages 10a to 10f and the components such as the compressor 2. Hereinafter, the flow passage 10f is referred to as “the injection flow passage 10f”.

The flow passage 10g has an upstream end E₁ (one end) connected to the flow passage 10b and a downstream end E₂ (the other end) connected to the injection flow passage 10f. That is, the flow passage 10g is a flow passage for connecting the flow passage 10d to the injection flow passage 10f. The bypass valve 8 is provided on the flow passage 10g and controls flow of the refrigerant in the flow passage 10g. Typically, the bypass valve 8 is composed of an on-off valve. The flow passage 10g and the bypass valve 8 are used to allow a pressure in the injection flow passage 10f to be a pressure equal to an outlet pressure of the compressor 2 at time of activation of the refrigeration cycle apparatus 100. Hereinafter, the flow passage 10g is referred to as “the bypass flow passage 10g”.

The position of the upstream end E₁ of the bypass flow passage 10g is not limited to the position shown in FIG. 1. That is, the upstream end E₁ of the bypass flow passage 10g may be located at any position on a high pressure flow passage. Here, the “high pressure flow passage” refers to the flow passages 10a and 10b connecting the compressor 2, the radiator 3 and the positive displacement fluid machine 4 in this order so that the refrigerant discharged from the compressor 2 is supplied to the radiator 3 and the refrigerant that has flowed out of the radiator 3 is supplied to the positive displacement fluid machine 4. Thus, the upstream end E₁ of the bypass flow passage 10g may be located on the flow passage 10a. In some cases, the bypass flow passage 10g may be branched from the radiator 3. For example, in the case where the radiator 3 is composed of an upstream portion and a downstream portion, the bypass flow passage 10g can be branched easily from between these two portions.

In this description, “an outlet pressure of the compressor 2” refers to a pressure of the refrigerant at an outlet of the compressor 2. Likewise, “an inlet pressure of the compressor 2” refers to a pressure of the refrigerant at an inlet of the compressor 2. “An inlet temperature (or an inlet pressure) of the positive displacement fluid machine 4” refers to a temperature (or a pressure) of the refrigerant at an inlet of the positive displacement fluid machine 4. “An outlet temperature (or an outlet pressure) of the positive displacement fluid machine 4” refers to a temperature (or a pressure) of the refrigerant at an outlet of the positive displacement fluid machine 4. Specifically, the “outlet” and the “inlet” refer to a discharge pipe and a suction pipe, respectively.

The expansion valve 6 is provided on the flow passage 10e connecting the gas-liquid separator 5 to the evaporator 7. The expansion valve 6 can lower the pressure of the refrigerant that has been separated out in the gas-liquid separator 5 and that is to be heated in the evaporator 7. Thereby, the refrigerant that has flowed out of the evaporator 7 can be drawn smoothly into the positive displacement fluid machine 4 through the injection flow passage 10f. Moreover, by closing the expansion valve 6 at time of activation of the refrigeration cycle apparatus 100, it is possible to prevent the pressure in the injection flow passage 10f from being equal to a suction pressure of the compressor 2.

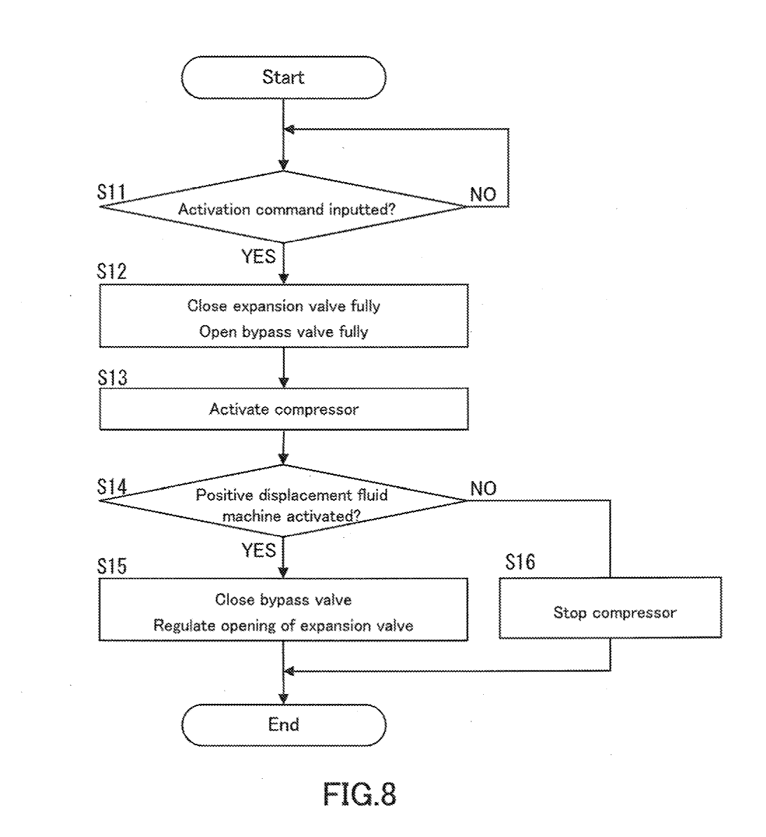

The refrigeration cycle apparatus 100 further includes a controller 102. The controller 102 controls the motor 2b of the compressor 2, the expansion valve 6 and the bypass valve 8. Typically, the controller 102 is composed of a microcomputer having an internal memory, a CPU, etc. When a command (turn-on of an activation switch, for example) to start operation of the refrigeration cycle apparatus 100 is given to the controller 102, a specified control program stored in the internal memory of the controller 102 is executed by the CPU. The specified control program includes an activation control program that is described later with reference to FIG. 8.

The refrigeration cycle apparatus 100 further includes an activation detector 104 for detecting the activation of the positive displacement fluid machine 4. The controller 102 switches a control method of the refrigeration cycle apparatus 100 from the activation control to a normal control, based on a result of detection by the activation detector 104. In the activation control, the expansion valve 6 is closed and the bypass valve 8 is opened so that the high pressure refrigerant is guided to the injection flow passage 10f. Thereby, the positive displacement fluid machine 4 is activated smoothly. After the positive displacement fluid machine 4 is activated, the bypass valve 8 is closed so that the low pressure refrigerant is guided from the evaporator 7 to the injection flow passage 10f, in accordance with the normal control. For example, the controller 102 closes the bypass valve 8 in response to receiving, from the activation detector 104, a signal indicating that the positive displacement fluid machine 4 is activated.

First, the basic operation of the refrigeration cycle apparatus 100 and the specific configuration of the positive displacement fluid machine 4 that can establish this basic operation are described. Thereafter, the activation control of the refrigeration cycle apparatus 100 is described.

The compressor 2 draws the refrigerant and compresses the drawn refrigerant. The compressed refrigerant is cooled in the radiator 3 while remaining at a high pressure. The cooled refrigerant is decompressed to an intermediate pressure in the positive displacement fluid machine 4 to be turned into a gas-liquid two phase. The gas-liquid two phase refrigerant flows into the gas-liquid separator 5 and is separated into a gas refrigerant and a liquid refrigerant. The gas refrigerant is drawn into the compressor 2. The liquid refrigerant is decompressed by the expansion valve 6 and supplied to the evaporator 7. The refrigerant is heated and evaporated in the evaporator 7. The gas refrigerant that has flowed out of the evaporator 7 is drawn into the positive displacement fluid machine 4 and compressed preliminarily to an intermediate pressure. The gas refrigerant that has been compressed to the intermediate pressure passes again through the gas-liquid separator 5 to be drawn into the compressor 2. The pressure of the refrigerant drawn into the compressor 2 is increased to an intermediate pressure, so that the load on the compressor 2 is reduced. Thereby, the COP of the refrigeration cycle apparatus 100 is improved.

The cycle specified in the above stages is equivalent to a so-called “ejector cycle”. In the ejector cycle well known to a person skilled in the art, an “ejector”, which is a kind of non-positive-displacement fluid machine, is used. In contrast, the refrigeration cycle apparatus 100 of the present embodiment can constitute a cycle equivalent to the ejector cycle by including the positive displacement fluid machine 4.

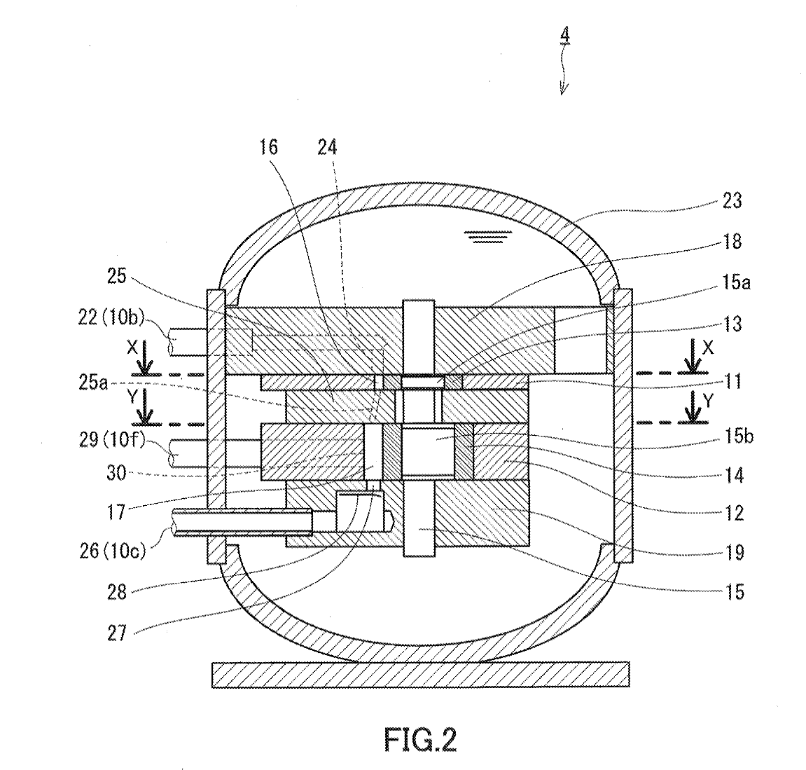

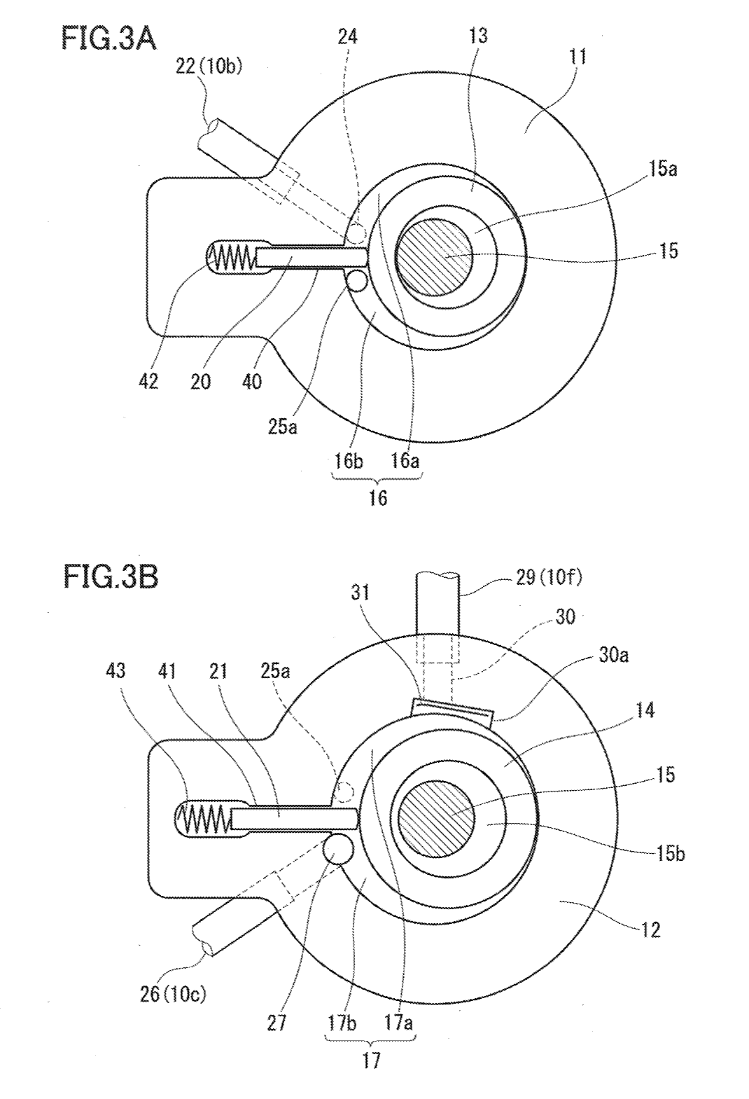

FIG. 2 is a vertical cross-sectional view of the positive displacement fluid machine shown in FIG. 1. FIG. 3A and FIG. 3B are transverse cross-sectional views of the positive displacement fluid machine, taken along the line X-X and Y-Y, respectively. The positive displacement fluid machine 4 has a closed casing 23, a shaft 15, an upper bearing 18, a first cylinder 11, a first piston 13, a first vane 20, an intermediate plate 25, a second cylinder 12, a second piston 14, a second vane 21 and a lower bearing 19. The positive displacement fluid machine 4 is constituted as a two-stage rotary fluid machine. Parts, such as the cylinders, are accommodated in the closed casing 23.

As shown in FIG. 2, the shaft 15 has a first eccentric portion 15a and a second eccentric portion 15b. The first eccentric portion 15a and the second eccentric portion 15b each protrude radially outward. The shaft 15 extends through the first cylinder 11 and the second cylinder 12, and is supported rotatably by the upper bearing 18 and the lower bearing 19. The rotation axis of the shaft 15 coincides with the respective centers of the first cylinder 11 and the second cylinder 12. The second cylinder 12 is disposed concentrically with respect to the first cylinder 11, and separated from the first cylinder 11 by the intermediate plate 25. The first cylinder 11 is closed by the upper bearing 18 and the intermediate plate 25, and the second cylinder 12 is closed by the intermediate plate 25 and the lower bearing 19.

As shown in FIG. 3A, the first piston 13 has a ring shape in plan view, and is disposed inside the first cylinder 11 so as to form a crescent-shaped first space 16 between itself and the first cylinder 11. Inside the first cylinder 11, the first piston 13 is fitted around the first eccentric portion 15a of the shaft 15. A first vane groove 40 is formed in the first cylinder 11. The first vane 20 is placed slidably in the first vane groove 40. The first vane 20 partitions the first space 16 along the circumferential direction of the first piston 13. Thereby, a first suction space 16a and a first discharge space 16b are formed inside the first cylinder 11.

As shown in FIG. 3B, the second piston 14 has a ring shape in plan view, and is disposed inside the second cylinder 12 so as to form a crescent-shaped second space 17 between itself and the second cylinder 12. Inside the second cylinder 12, the second piston 14 is fitted around the second eccentric portion 15b of the shaft 15. A second vane groove 41 is formed in the second cylinder 12. The second vane 21 is placed slidably in the second vane groove 41. The second vane 21 partitions the second space 17 along the circumferential direction of the second piston 14. Thereby, a second suction space 17a and a second discharge space 17b are formed inside the second cylinder 12.

The second space 17 has a larger volumetric capacity than that of the first space 16. Specifically, in the present embodiment, the second cylinder 12 has a larger thickness than that of the first cylinder 11. Furthermore, the second cylinder 12 has a larger inner diameter than that of the first cylinder 11. The dimensions of each part are adjusted appropriately so that the second space 17 has a larger volumetric capacity than that of the first space 16.

With respect to the rotational direction of the shaft 15, the direction in which the first eccentric portion 15a protrudes coincides with the direction in which the second eccentric portion 15b protrudes. With respect to the rotational direction of the shaft 15, the angular position at which the first vane 20 is disposed coincides with the angular position at which the second vane 21 is disposed. Thus, the timing at which the first piston 13 reaches its top dead center coincides with the timing at which the second piston 14 reaches its top dead center. The phrase “timing at which the piston reaches its top dead center” refers to the timing at which the vane is pressed maximally into the vane groove by the piston.

As shown respectively in FIG. 3A and FIG. 3B, a first spring 42 is disposed behind the first vane 20 and a second spring 43 is disposed behind the second vane 21. The first spring 42 and the second spring 43 press the first vane 20 and the second vane 21, respectively, toward the center of the shaft 15. A lubricating oil held in the closed casing 23 is supplied to the first vane groove 40 and the second vane groove 41. The first piston 13 and the first vane 20 may be formed of a single component, a so-called swing piston. The first vane 20 may be engaged with the first piston 13. This is also the case with the second piston 14 and the second vane 21.

As shown in FIG. 2, the positive displacement fluid machine 4 further has a suction pipe 22, a suction port 24, a discharge pipe 26, a discharge port 27, an injection port 30 and an injection suction pipe 29. The refrigerant can be supplied to the first space 16 (specifically, the first suction space 16a) through the suction port 24. The refrigerant can be discharged from the second space 17 (specifically, the second discharge space 17b) through the discharge port 27. The suction pipe 22 and the discharge pipe 26 are connected to the suction port 24 and the discharge port 27, respectively. The suction pipe 22 constitutes a part of the flow passage 10b in the refrigerant circuit 10 (FIG. 1). The discharge pipe 26 constitutes a part of the flow passage 10c in the refrigerant circuit 10. The discharge port 27 is provided with a discharge valve 28 (a check valve) for preventing backflow of the refrigerant from the flow passage 10c to the second discharge space 17b. Typically, the discharge valve 28 is a reed valve made of a metal thin plate. The discharge valve 28 is opened when the pressure in the second discharge space 17b exceeds the pressure in the discharge pipe 26 (the pressure in the flow passage 10c). When the pressure in the second discharge space 17b is equal to or lower than the pressure in the discharge pipe 26, the discharge valve 28 is closed.

The suction port 24 and the discharge port 27 are formed in the upper bearing 18 and the lower bearing 19, respectively. However, the suction port 24 may be formed in the first cylinder 11 and the discharge port 19 may be formed in the second cylinder 12.

The intermediate plate 25 is provided with a communication hole 25a (a communication flow passage). The communication hole 25a extends through the intermediate plate 25 in the thickness direction. The first discharge space 16b of the first cylinder 11 is in communication with the second suction space 17a of the second cylinder 12 through the communication hole 25a. Thereby, the first discharge space 16b, the communication hole 25a and the second suction space 17a can function as one working chamber. Since the volumetric capacity of the second space 17 is larger than the volumetric capacity of the first space 16, the refrigerant confined in the first discharge space 16b, the communication hole 25a and the second suction space 17a expands while rotating the shaft 15.

In the positive displacement fluid machine 4, the “working chamber” is formed of the first space 16, the second space 17 and the communication hole 25a. The working chamber increases its volumetric capacity to expand the refrigerant and reduces its volumetric capacity to compress the refrigerant. Specifically, the first suction space 16a functions as a working chamber into which the refrigerant is drawn. The first discharge space 16b, the communication hole 25a and the second suction space 17a function as a working chamber in which the refrigerant is expanded and overexpanded. The second discharge space 17b functions as a working chamber in which the refrigerant is recompressed and from which the refrigerant is discharged.

Particularly, in the present embodiment, the ratio (V2/V1) of a volumetric capacity V2 of the second space 17 to a volumetric capacity V1 of the first space 16 is adjusted to a value that allows the refrigerant drawn into the positive displacement fluid machine 4 to be expanded and overexpanded in the working chamber formed of the first discharge space 16b, the communication hole 25a and the second suction space 17a. That is, the volumetric capacity V2 is far larger than the volumetric capacity V1. Specifically, the volumetric capacity ratio (V2/V1) is set to be almost equal to the ratio (V_{SEP}/V_{GC}) of a volumetric flow rate V_{SEP} of the refrigerant at the inlet of the gas-liquid separator 5 to a volumetric flow rate V_{GC} of the refrigerant at an outlet of the radiator 3.

The injection port 30 is formed at a position that allows the refrigerant to be supplied to the second suction space 17a through the injection port 30. Specifically, the injection port 30 is formed in the second cylinder 12. The injection port 30 is provided with a check valve 31 for preventing backflow of the refrigerant from the second suction space 17a or the second discharge space 17b to the injection flow passage 10f. Typically, the check valve 31 is a reed valve made of a metal thin plate.

Specifically, the second cylinder 12 is provided with a recessed portion 30a facing the second space 17. The injection port 30 opens into the recessed portion 30a. The check valve 31 is fixed to the recessed portion 30a so as to open and close the injection port 30. The check valve 31 is opened when the pressure in the second suction space 17a falls below the pressure in the injection suction pipe 29 (the pressure in the injection flow passage 10f). The check valve 31 is closed when the pressure in the second suction space 17a is equal to or higher than the pressure in the injection suction pipe 29.

In the present embodiment, the position where the second vane 21 is disposed (the position of the second vane groove 41), with respect to the rotational direction of the shaft 15, is defined as a “reference position” having an angle of 0 degrees. Since the position at which the first vane 20 is disposed coincides with the position at which the second vane 21 is disposed, the position at which the first vane 20 is disposed also coincides with the reference position. The injection port 30 is provided at a position in the range of, for example, 45 to 135 degrees with respect to the rotational direction of the shaft 15. By providing the injection port 30 at a position in such a range, it is possible to prevent the high pressure refrigerant from flowing from the suction port 24 directly to the injection port 30 through a gap at the check valve 31. Moreover, it is possible to prevent the recovered power from decreasing due to expansion of the refrigerant in the recessed portion 30a. This is because when the high pressure drawn refrigerant enters into the recessed portion 30a that is a dead volume and is expanded in the recessed portion 30a, power cannot be recovered from the refrigerant expanded in the recessed portion 30a.

Unless the pressure in the second space 17 falls below the pressure in the injection suction pipe 29, the refrigerant does not flow into the second space 17 through the injection port 30. Thus, the position of the injection port 30 is not particularly limited. The injection port 30 may be located near the second vane 21, for example. Furthermore, the injection port 30 may be opened into the communication port 25a.

The suction port 24 is provided at a position in the range of, for example, 0 to 40 degrees. The communication hole 25a is provided at a position in the range of, for example, 0 to 40 degrees when viewed from the second cylinder 12 side. The discharge port 27 is provided at a position in the range of, for example, 320 to 360 degrees.

As can be understood from the positional relationship among the suction port 24, the communication hole 25a and the injection port 30, the injection port 30 is provided at a position that does not allow the injection port 30 to be in communication with the suction port 24 through the working chamber (the first space 16, the communication hole 25a and the second space 17). Such a configuration prevents the recovered power from decreasing due to the expansion of the refrigerant in the recessed portion 30a.

The opening area of the suction port 24, the opening area of the injection port 30 and the opening area of the discharge port 27 should be set appropriately taking into account the flow rate (volumetric flow rate) of the refrigerant passing through each of these ports. In the refrigeration cycle apparatus 100, the refrigerant flowing through the injection flow passage 10f has a very high volumetric flow rate. That is, the refrigerant passing through the injection port 30 has a very high volumetric flow rate. In contrast, the refrigerant passing through the suction port 24 has a relatively low volumetric flow rate because it is in a liquid phase (chlorofluorocarbon alternative) or in a supercritical state (CO₂). Therefore, it is desirable that the opening area of the injection port 30 is larger than that of the suction port 24, from the viewpoint of reducing the pressure loss.

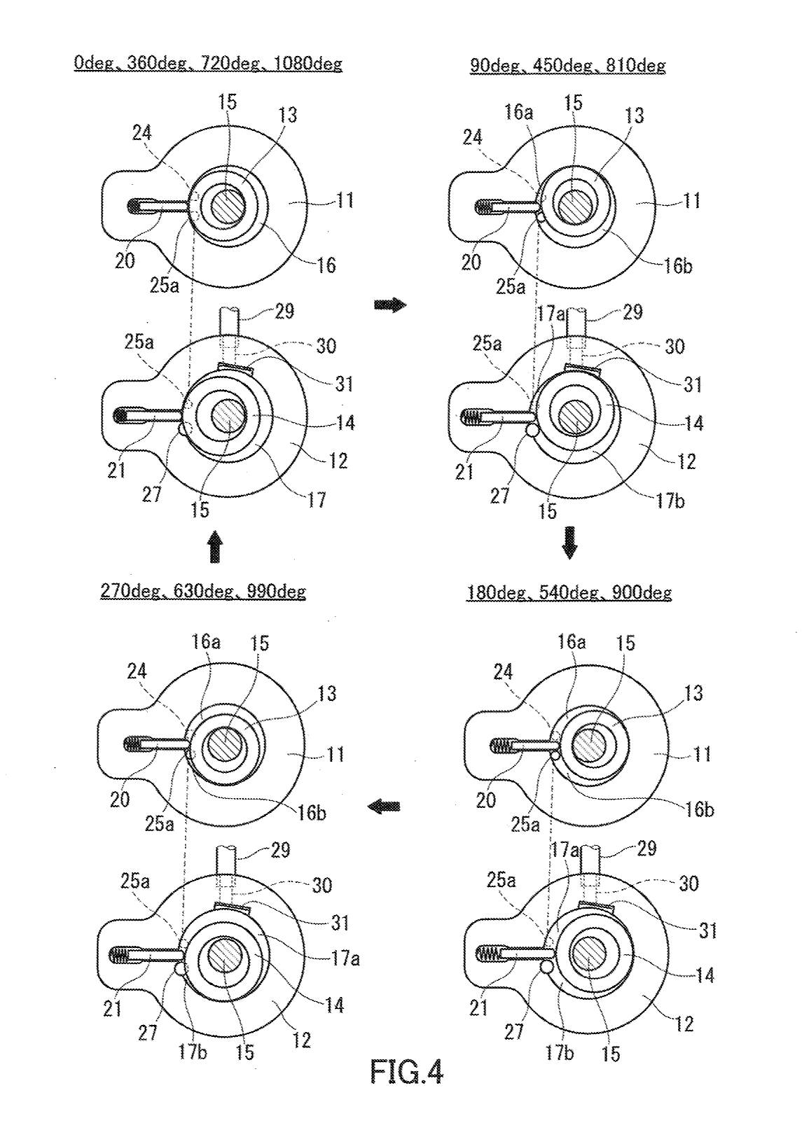

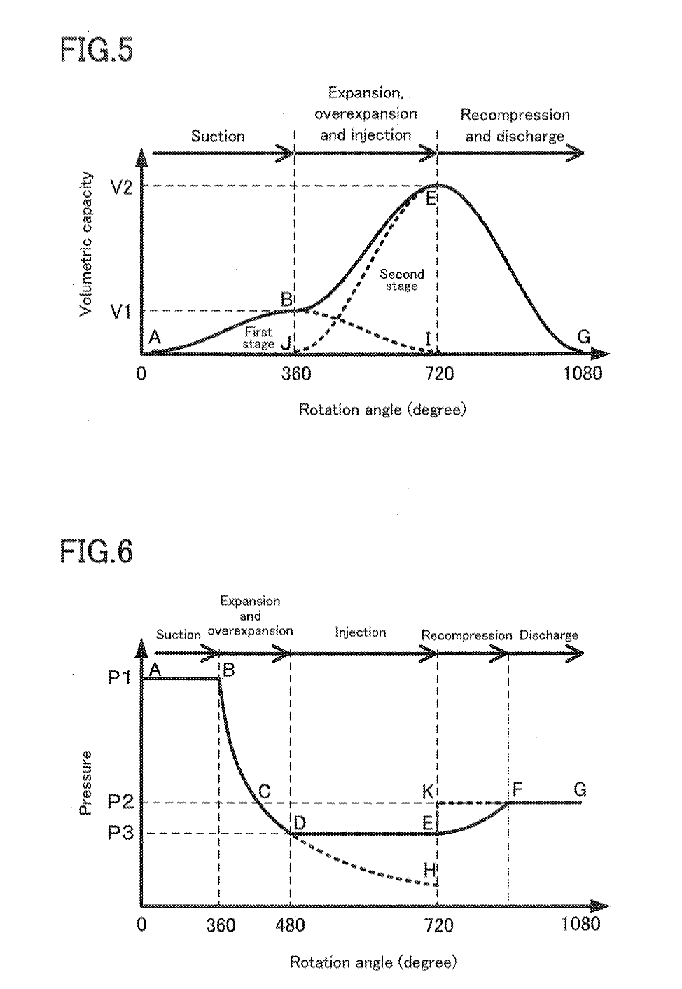

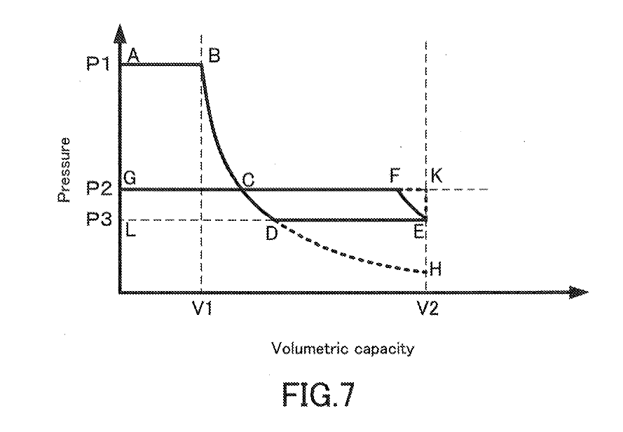

Next, the operation of the positive displacement fluid machine is described in detail with reference to FIGS. 4 to 7. FIG. 4 is an a diagram illustrating the operation principle of the positive displacement fluid machine. The upper left diagram, upper right diagram, lower right diagram and lower left diagram in FIG. 4 each show the positions of the first piston 13 and the second piston 14 when the shaft 15 is rotated 90 degrees each. FIG. 5 is a graph showing a relationship between the rotation angle of the shaft from the reference position and the volumetric capacity of the working chamber. FIG. 6 is a graph showing a relationship between the rotation angle of the shaft from the reference position and the pressure in the working chamber. FIG. 7 is a graph showing a relationship between the pressure in the working chamber and the volumetric capacity of the working chamber (between the pressure of the refrigerant and the volume of the refrigerant).

As shown in the upper left diagram and the upper right diagram in FIG. 4, in the first cylinder 11, the first suction space 16a is newly generated adjacent to the suction port 24 when the shaft 15 rotates from the position of 0 degrees to the position of 90 degrees. Thereby, the refrigerant cooled in the radiator 3 is drawn into the first suction space 16a through the suction port 24 (suction process). As the shaft 15 rotates, the volumetric capacity of the first suction space 16a increases. When the shaft 15 rotates 360 degrees, the volumetric capacity of the first suction space 16a reaches to its maximum capacity (=the volumetric capacity of the first space 16). Thereby, the suction process is completed.

In FIG. 5, the line AB indicates the change in the volumetric capacity of the first suction space 16a during the suction process. The suction process is completed at the point B. The volumetric capacity V1 at the point B corresponds to the volumetric capacity of the first space 16 of the first cylinder 11. In FIG. 6, the line AB indicates the suction process. The refrigerant drawn into the first suction space 16a during the suction process is the refrigerant that has been cooled in the radiator 3 while maintaining a high pressure, and the refrigerant has a suction pressure P1 (a first pressure).

Next, as shown in the upper left diagram and the upper right diagram in FIG. 4, the first suction space 16a changes into the first discharge space 16b when the shaft 15 rotates from the position of 360 degrees to the position of 450 degrees. In the second cylinder 12, the second suction space 17a is newly generated adjacent to the communication hole 25a. The first discharge space 16b is in communication with the second suction space 17a through the communication hole 25a. The first discharge space 16b, the communication hole 25a and the second suction space 17a form one working chamber that is in communication neither with the suction port 24 nor with the discharge port 27. As the shaft 15 rotates, the refrigerant is expanded to a discharge pressure P2 (a second pressure) in the working chamber formed of the first discharge space 16b, the communication hole 25a and the second suction space 17a (expansion process).

The amount of increase in the volumetric capacity of the second suction space 17a is significantly larger than the amount of decrease in the volumetric capacity of the first discharge space 16b, when the shaft 15 rotates only an unit angle. Thus, the refrigerant is expanded rapidly, and the pressure of the refrigerant falls below the discharge pressure P2 when the shaft 15 occupies the position of 450 degrees. As the shaft 15 rotates, the refrigerant is overexpanded to a pressure P3 (a third pressure) that is lower than the discharge pressure P2 (overexpansion process).

In the expansion process and the overexpansion process, the refrigerant releases pressure energy. The pressure energy released from the refrigerant is converted into a torque of the shaft 15 via the pistons 13 and 14. That is, the positive displacement fluid machine 4 recovers power from the refrigerant.

On the other hand, when the rotation angle of the shaft 15 exceeds 450 degrees, the refrigerant can be supplied to the second suction space 17a through the injection port 30. When the overexpansion of the refrigerant proceeds and the pressure in the second suction space 17a falls below the pressure in the injection suction pipe 29, that is, the evaporating pressure in the evaporator 7, the overexpansion of the refrigerant stops. At the same time, the refrigerant having the pressure P3 is supplied to the second suction space 17a through the injection port 30. In the second suction space 17a, the supplied refrigerant is mixed with the overexpanded refrigerant (injection process).

Thereafter, as shown in the lower right diagram and the lower left diagram in FIG. 4, the refrigerant having the pressure P3 continues being supplied to the second suction space 17a through the injection port 30 until the rotation angle of the shaft 15 reaches 720 degrees. As shown in the upper left diagram in FIG. 4, when the shaft 15 rotates to the position of 720 degrees, the volumetric capacity of the second suction space 17a reaches its maximum capacity (=the volumetric capacity of the second space 17). Thereby, the injection process is completed.

In FIG. 5, the dashed line BI indicates the change in the volumetric capacity of the first discharge space 16b during the expansion process, the overexpansion process and the injection process. The dashed line JE indicates the change in the volumetric capacity of the second suction space 17a. The line BE indicates the change in the volumetric capacity of the working chamber formed of the first discharge space 16b, the communication hole 25a and the second suction space 17a. The expansion process, the overexpansion process and the injection process are completed at the point E. The volumetric capacity V2 at the point E corresponds to the volumetric capacity of the second space 17 of the second cylinder 12.

In FIG. 6, the lines BC, CD and DE indicate the expansion process, the overexpansion process and the injection process, respectively. As the shaft 15 rotates, the pressure in the working chamber formed of the first discharge space 16b, the communication hole 25a and the second suction space 17a lowers from the pressure P1 observed at the start of the expansion process. As mentioned above, the ratio (V2/V1) of the volumetric capacity V2 of the second space 17 to the volumetric capacity V1 of the first space 16 is very high. Thus, assuming that the injection port 30 is omitted, the pressure in the working chamber lowers along the dashed line DH on the extension of the line BCD even after lowering to the pressure P3 of the refrigerant in the evaporator 7. However, since the positive displacement fluid machine 4 used in the refrigeration cycle apparatus 100 of the present embodiment has the injection port 30, the refrigerant having the pressure P3 that has flowed out of the evaporator 7 is supplied to the second suction space 17a through the injection port 30 when the pressure in the working chamber lowers to the pressure P3. Thus, the pressure in the working chamber stops lowering, and the refrigerant having the pressure P3 continues being supplied to the working chamber until the volumetric capacity of the working chamber reaches the volumetric capacity V2 specified at the point E in FIG. 5. Thereby, the expansion process, the overexpansion process and the injection process are completed.

Next, as shown in the upper left diagram and the upper right diagram in FIG. 4, the second suction space 17a changes into the second discharge space 17b when the shaft 15 rotates from the position of 720 degrees to the position of 810 degrees. The discharge port 27 faces the second discharge space 17b. However, as described with reference to FIG. 2, the discharge port 27 is provided with the discharge valve 28. Thus, the refrigerant is compressed in the second discharge space 17b until the pressure in the second discharge space 17b exceeds the pressure in the discharge pipe 26, that is, the suction pressure in the compressor 2 (recompression process). The refrigerant to be compressed in the second discharge space 17b includes a fraction of the refrigerant drawn into the positive displacement fluid machine 4 through the suction port 24 and a fraction of the refrigerant drawn into the positive displacement fluid machine 4 through the injection port 30.

The power recovered from the refrigerant during the expansion process and the overexpansion process is used to compress the refrigerant during the recompression process. As can be understood from the upper left diagram and the upper right diagram in FIG. 4, when the recompression process is performed in the second discharge space 17b, the expansion process and the overexpansion process are performed in the newly generated second suction space 17a. The power recovered from the refrigerant during the expansion process and the overexpansion process is consumed as energy for compressing the refrigerant during the recompression process.

In the present embodiment, the expansion process and the overexpansion process continue from a point of time when the first discharge space 16b is brought into communication with the second suction space 17a through the communication hole 25a until a point of time when the pressure in the second suction space 17a becomes equal to the pressure P3 (the third pressure) in the injection flow passage 10f. The recompression process continues from a point of time when the communication between the first discharge space 16b and the second suction space 17a through the communication hole 25a is interrupted until a point of time when the pressure in the second discharge space 17b becomes equal to the pressure P2 (the second pressure) in the flow passage 10c. In a period during which the shaft 15 makes one rotation, at least a part of a period during which the expansion process and the overexpansion process are performed is overlapped with a period during which the recompression process is performed. With such a configuration, unevenness in the torque of the shaft 15 is less likely to occur. This contributes to stable operation of the positive displacement fluid machine 4.

When the pressure in the second discharge space 17b exceeds the pressure in the discharge pipe 26, the discharge valve 28 is opened. Thereby, the refrigerant is discharged from the second discharge space 17b to the discharge pipe 26 through the discharge port 27 (discharge process). As the shaft 15 rotates, the volumetric capacity of the second discharge space 17b decreases, and the second discharge space 17b disappears when the shaft 15 rotates to the position of 1080 degrees. Thereby, the discharge process is completed.

In FIG. 5, the line EG indicates the change in the volumetric capacity of the second discharge space 17b during the recompression process and the discharge process. In FIG. 6, the line EF and the line FG indicate the recompression process and the discharge process, respectively. Immediately after the completion of the expansion process and the overexpansion process, the pressure P3 of the refrigerant is lower than the pressure P2 in the discharge pipe 26. At this time, the discharge valve 28 is closed. As the volumetric capacity of the second discharge space 17b decreases, the refrigerant is recompressed to the pressure P2. Thereafter, the pressure in front of the discharge valve 28 is balanced with the pressure behind the discharge valve 28, so that the discharge valve 28 is opened and the refrigerant having the pressure P2 is discharged from the second discharge space 17b to the discharge pipe 26. The discharge process is completed at the point G.

FIG. 7 is a P-V diagram showing a relationship between the pressure in the working chamber and the volumetric capacity of the working chamber. The line AB indicates the suction process, the line BC indicates the expansion process, the line CD indicates the overexpansion process, the line DE indicates the injection process, the line EF indicates the recompression process, and the line FCG indicates the discharge process. The energy that the positive displacement fluid machine 4 recovers from the refrigerant corresponds to the area of the region surrounded by the points A, B, C, D, L and G. The work necessary to recompress the overexpanded refrigerant corresponds to the area of the region surrounded by the points L, D, E, F, C and G. The recovered energy, the work necessary for the recompression, and various losses are balanced with each other. Thus, the positive displacement fluid machine 4 rotates autonomously without a motor or the like. Since the region surrounded by the points C, D, L and G is common between the recovered energy and the work necessary for the recompression, it can be cancelled. Eventually, the energy corresponding to the area of the region surrounded by the points A, B, C and G is recovered from the refrigerant, and the work corresponding to the area of the region surrounded by the points C, D, E and F is performed on the refrigerant by using the recovered energy.

As described above, in the present embodiment, the expansion process, the overexpansion process and the recompression process are performed as a sequence of steps between the suction process and the discharge process. Thus, in the present embodiment, unlike in the refrigeration cycle apparatus described in Patent Literature 1, the expander and the sub compressor do not need to be provided independently and it is possible to perform each step mentioned above by using the positive displacement fluid machine 4 having a simple structure. The parts count of the positive displacement fluid machine 4 is less than that in the case where the expander and the sub compressor are provided independently. Therefore, the production cost of the refrigeration cycle apparatus 100 can be suppressed.

Moreover, since the injection port 30 is provided with the check valve 31, it is possible to prevent backflow of the refrigerant from the second discharge space 17b to the injection port 30 during the recompression process and the discharge process. This contributes to the enhancement in the efficiency of the positive displacement fluid machine 4. In FIG. 4, the check valve 31 prevents the backflow of the refrigerant from the second discharge space 17b to the injection port 30 during the period in which the shaft 15 rotates from the position of 720 degrees to the position of 810 degrees.

Furthermore, since the discharge port 27 is provided with the discharge valve 28, the work for recompressing and discharging the refrigerant can be reduced. When the discharge valve 28 is not provided, backflow of the refrigerant may occur from the discharge pipe 26 (the flow passage 10c) to the second discharge space 17b at the moment when the rotation angle of the shaft 15 exceeds 720 degrees and the discharge port 27 faces the second discharge space 17b. In the case where the backflow of the refrigerant occurs, the recompression process and the discharge process are indicated by the line EKFG in FIG. 6 and by the line EKFCG in FIG. 7. That is, the work corresponding to the area of the region surrounded by the points E, K and F is needed as an extra work for recompressing and discharging the refrigerant. This drawback can be avoided by providing the discharge valve 28, and thereby the work for recompressing and discharging the refrigerant can be reduced and also the efficiency of the positive displacement fluid machine 4 is enhanced. In addition, explosive sound caused by connecting directly the suction pipe 26 filled with the refrigerant having the pressure P3 to the second discharge space 17b filled with the refrigerant having the pressure P2 can be prevented from occurring. Accordingly, noise and vibration of the positive displacement fluid machine 4 can be suppressed.

In the present embodiment, the positive displacement fluid machine 4 has a structure of a two-stage rotary fluid machine. The expansion process and the overexpansion process proceed in the working chamber formed of the first discharge space 16b, the communication hole 25a and the second suction space 17a, and the recompression process and the discharge process proceed in the second discharge space 17b. That is, the expansion process and the overexpansion process proceed at the same time with the recompression process and the discharge process in the positive displacement fluid machine 4. Thus, the energy recovery from the refrigerant can be performed at the same time with the compression work to the refrigerant. In the case where the energy recovery is performed at the same time with the compression work, the change in the rotating speed of the shaft 15 is less than in the case where they are performed alternately. Thereby, it is possible to operate stably the positive displacement fluid machine 4 and also to reduce the noise and vibration of the positive displacement fluid machine 4. Moreover, it is possible to prevent the shaft 15 from slowing down and stopping due to the change in the rotating speed of the shaft 15 when the circulation amount of the refrigerant in the refrigerant circuit 10 is small.

In addition, use of the two-stage rotary fluid machine can provide the following advantages. That is, it is easy to set the ratio (V2/V1) of the volumetric capacity V2 of the second space 17 to the volumetric capacity V1 of the first space 16 to be close to the ratio (V_{SEP}/V_{GC}) of the volumetric flow rate V_{SEP} of the refrigerant at the inlet of the gas-liquid separator 5 to the volumetric flow rate V_{GC} of the refrigerant at the outlet of the radiator 3.

In the present embodiment, the refrigerant to be supplied to the injection port 30 of the positive displacement fluid machine 4 through the injection flow passage 10f is a gas refrigerant. Specifically, the refrigerant that has received heat from a low temperature side heat source (air, for example) and evaporated from a liquid to a gas in the evaporator 7 is injected into the positive displacement fluid machine 4. Since the work to compress, in the positive displacement fluid machine 4, the refrigerant (liquid refrigerant) making no contribution to the thermal energy absorption from the low temperature side heat source is reduced, the COP of the refrigeration cycle apparatus 100 is enhanced. Therefore, it is preferable to regulate the expansion valve 6 (the expansion valve 45 in Embodiment 2 described later) so that the refrigerant having a dryness of 1.0 or the overheated refrigerant (that is, only the gas refrigerant) is supplied to the injection port 30.

The refrigeration cycle apparatus 100 of the present embodiment can be used suitably in a hot water supply appliance and a hot water heater. For the purposes of the hot water supply and hot water heating, switching between cooling and heating, as in an air conditioner, is not necessary. That is, components, such as a four-way valve, can be omitted and further cost reduction can be expected.

Use of the refrigeration cycle apparatus 100 in a hot water supply appliance and a hot water heater provides the following advantages. Usually, the hot water supply appliance performs a rated operation in the case of reserving hot water in a tank by using night power. The hot water heater usually performs a continuous operation. When a certain period of time has elapsed since the starting of the hot water heater, the load on the hot water heater is stabilized because the temperature in a building becomes constant. Taking such an operation style into account, the ratio of the volumetric flow rate of the refrigerant at the inlet of the gas-liquid separator 5 to the volumetric flow rate of the refrigerant at the outlet of the radiator 3 is almost constant. Thus, it is easy to make the ratio (V2/V1) of the volumetric capacity V2 of the second space 17 to the volumetric capacity V1 of the first space 16 coincide with the volumetric flow rate ratio. Thereby, the effect of power recovery can be obtained more sufficiently.

The high pressure and the low pressure of a supercritical refrigerant typified by carbon dioxide is different largely in the refrigeration cycle. Specifically, there is a large difference between the suction pressure P1 and the discharge pressure P2 in the positive displacement fluid machine 4. Accordingly, the power that can be recovered by the positive displacement fluid machine 4 also is large. Thus, carbon dioxide is appropriate as the refrigerant for the refrigeration cycle apparatus 100. However, the type of the refrigerant is not particularly limited, and a natural refrigerant other than carbon dioxide, a chlorofluorocarbon alternative such as R410A, and a low GWP (Global Warming Potential) refrigerant such as R1234yf can be used.

By using the positive displacement fluid machine 4 in the refrigeration cycle apparatus 100 as a means to recover power from the refrigerant, it is possible to utilize the recovered power as a part of the compression work. Since the difference between the suction pressure and the discharge pressure in the compressor 2 is reduced, the load on the compressor 2 is reduced and the COP of the refrigeration cycle apparatus 100 is improved. It should be noted, however, that the positive displacement fluid machine 4 described in the present embodiment may be usable also in apparatuses other than the refrigeration cycle apparatus.

Next, the activation control to be executed by the controller 102 at time of activation of the refrigeration cycle apparatus 100 is described. The activation control is a control for allowing the pressure in the injection flow passage 10f to be a pressure equal to the outlet pressure of the compressor 2 instead of the third pressure (the pressure P3 shown in FIG. 6). FIG. 8 is a flow chart illustrating the activation control of the refrigeration cycle apparatus. The controller 102 executes the activation control shown in FIG. 8 and then performs a normal operation. During the time when the refrigeration cycle apparatus 100 is stopped, the expansion valve 6 is opened and the pressure of the refrigerant in the refrigerant circuit 10 is almost uniform.

If an activation command is inputted in Step S11, a control signal is sent to an actuator of the expansion valve 6 to close fully the expansion valve 6. Furthermore, a control signal is sent to an actuator of the bypass valve 8 to open the bypass valve 8. Thereby, the bypass flow passage 10g is opened through (Step S12). The “activation command” refers to a command to start operation of the refrigeration cycle apparatus 100, and is issued when, for example, the activation switch of the refrigeration cycle apparatus 100 is turned on.

Subsequently, an electric power supply to the motor 2b is started to activate the compressor 2 (Step S13). The compressor 2 draws the refrigerant present in the flow passage 10d, the gas-liquid separator 5, the flow passage 10c, and a part of the flow passage 10e (a portion between the gas-liquid separator 5 and the expansion valve 6). The bypass valve 8 may be opened immediately after the compressor 2 is activated instead of being opened before the compressor 2 is activated. In response to the activation of the compressor 2, a fan or a pump for allowing a fluid (air or water) that is to exchange heat with the refrigerant to flow into the radiator 3 is activated. This can prevent the high pressure in the refrigeration cycle from increasing excessively.

When the compressor 2 starts drawing the refrigerant, the pressures in the flow passage 10d, etc. are lowered. On the other hand, the pressures are increased in the flow passage 10a, the radiator 3, the flow passage 10b, the bypass flow passage 10g, the injection flow passage 10f and the evaporator 7 because the refrigerant compressed in the compressor 2 is discharged therefrom. The pressure in the second suction space 17a of the positive displacement fluid machine 4 also is increased through the injection flow passage 10f and the injection port 30, and a high pressure is applied to the second piston 14. Since the second piston 14 has a surface area sufficiently larger than that of the first piston 13, the increased pressure in the second suction space 17a increases the torque for rotating the shaft 15. As a result, the positive displacement fluid machine 4 can be self-activated easily. The compressor 2 can draw, from the gas-liquid separator 5, the refrigerant in an amount sufficient to cause a large pressure difference.

If the activation of the positive displacement fluid machine 4 is detected via the activation detector 104 (Step S14), a control signal is sent to the actuator of the bypass valve 8 to close the bypass valve 8. Moreover, the opening of the expansion valve 6 is regulated so that the liquid refrigerant separated out in the gas-liquid separator 5 is supplied to the evaporator 7 (Step S15). When the bypass valve 8 is closed and the expansion valve 6 is opened, the refrigerant is supplied from the evaporator 7 to the positive displacement fluid machine 4 through the injection flow passage 10f. Moreover, the gas-liquid two phase refrigerant decompressed in the positive displacement fluid machine 4 is supplied to the gas-liquid separator 5. After the operation (activation operation) by the activation control shown in FIG. 8 ends, the operation state shifts to the operation (normal operation) by the normal control. In the normal operation, the refrigerant from the evaporator 7 is guided to the injection flow passage 10f. The normal control includes controls of the compressor 2 and the expansion valve 6, that is, controls to regulate the rotation speed of the compressor 2 and the opening of the expansion valve 6, but does not include control of the bypass valve 8. That is, the bypass valve 8 remains closed during the normal operation.

On the other hand, if the positive displacement fluid machine 4 fails to be activated, the compressor 2 is stopped (Step S16). Thereby, it is possible to prevent the pressures in the flow passage 10a, the radiator 3 and the flow passage 10b from increasing excessively and to ensure the reliability of the refrigeration cycle apparatus 100.

As mentioned above, the controller 102 executes the controls of the expansion valve 6 and the bypass valve 8 as the activation control. Thereby, the positive displacement fluid machine 4 can be activated smoothly. Preferably, the expansion valve 6 is opened stepwise (gradually) when the control method of the refrigeration cycle apparatus 100 is switched from the activation control to the normal control. Thereby, the change in load when the recompression process is performed in the positive displacement fluid machine 4 is lessened. Since it is possible to prevent the positive displacement fluid machine 4 from stalling due to an abrupt change in load, the switching from the activating operation to the normal operation can be performed smoothly.

To stop the operation of the refrigeration cycle apparatus 100, the rotation speed of the compressor 2 is reduced little by little, for example. After the compressor 2 stops, the refrigerant travels through the compressor 2 and the positive displacement fluid machine 4, taking sufficient time. Thus, the pressure difference in the refrigerant circuit 10 disappears naturally, so that the pressure in the refrigerant circuit 10 becomes almost uniform and stabilized. Thereby, the positive displacement fluid machine 4 also stops naturally.

Next, the activation detector 104 is described in detail. A temperature detector, a pressure detector or the like can be used as the activation detector 104. The activation detector 104 as a temperature detector includes, for example, a temperature detecting element such as a thermocouple and a thermistor, and can detect an inlet temperature Ti of the positive displacement fluid machine 4, an outlet temperature To of the positive displacement fluid machine 4, and a difference ΔT between the inlet temperature Ti and the outlet temperature To. The activation detector 104 as a pressure detector includes, for example, a piezoelectric element, and can detect an inlet pressure Pi of the positive displacement fluid machine 4, an outlet pressure Po of the positive displacement fluid machine 4, and a difference ΔP between the inlet pressure Pi and the outlet pressure Po. The activation detector 104 may include a timer for measuring time elapsed from a time point of activation of the compressor 2. Such a timer can be provided also as a function of the controller 102. That is, the controller 102 itself can serve as the activation detector 104. Furthermore, a contact or noncontact displacement sensor, such as an encoder, for detecting the rotation of the shaft 15 of the positive displacement fluid machine 4 may be provided as the activation detector 104.

The methods for determining whether the positive displacement fluid machine 4 is activated differ from each other as follows depending on the type of the activation detector 104. The methods described below make it possible to detect easily the activation of the positive displacement fluid machine 4.

In the case where a pressure detector for detecting the outlet pressure Po of the positive displacement fluid machine 4 is used as the activation detector 104, a threshold value Pₜₕ calculated experimentally or theoretically is set in the controller 102 in advance, for example. When a value obtained by subtracting an outlet pressure Poₙ (n is a natural number) detected by the pressure detector at a time point before a unit time from a current outlet pressure Poₙ₊₁ detected by the pressure detector exceeds the specified threshold value Pₜₕ, the activation of the positive displacement fluid machine 4 is detected. A single threshold value Pₜₕ, or a plurality of threshold values Pₜₕ corresponding to outside air temperature, etc. may be set in the controller 102. In the latter case, the controller 102 selects the most suitable threshold value Pₜₕ based on the outside air temperature, etc. This is also the case with the other threshold values described below.

The outlet pressure Po of the positive displacement fluid machine 4 decreases almost monotonically during a period that is after the compressor 2 is activated and until before the positive displacement fluid machine 4 is activated. When the positive displacement fluid machine 4 starts running, the outlet pressure Po increases. By recognizing this pressure change, it is possible to detect the activation of the positive displacement fluid machine 4. Specifically, the outlet pressure Po is detected every unit time and stored in the memory of the controller 102. The outlet pressure Poₙ stored last in the memory is compared with the current outlet pressure Poₙ₊₁. When the current outlet pressure Poₙ₊₁ exceeds the last-stored outlet pressure Poₙ by a certain value, it is determined that the positive displacement fluid machine 4 is activated. In other words, when (Poₙ₊₁−Poₙ)>Pₜₕ is satisfied, it is determined that the positive displacement fluid machine 4 is activated. The “unit time” can be set freely to a time sufficient to recognize an abrupt change in the outlet pressure Po, for example, a time in the range of 1 to 5 seconds.

It also is possible to use the outlet temperature To instead of the outlet pressure Po. That is, when a value obtained by subtracting an outlet temperature Toₙ (n is a natural number) detected by the temperature detector at a time point before a unit time from a current outlet temperature Toₙ₊₁ detected by the temperature detector exceeds a specified threshold value Tₜₕ, the activation of the positive displacement fluid machine 4 is detected.

The pressures in the flow passage 10c, the gas-liquid separator 5 and the flow passage 10d are equal to each other. Thus, a pressure in a flow passage (the flow passage 10c, the gas-liquid separator 5 and the flow passage 10d) from the outlet of the positive displacement fluid machine 4 to the inlet of the compressor 2 can be used as the outlet pressure Po of the positive displacement fluid machine 4. Likewise, a temperature in the flow passage from the outlet of the positive displacement fluid machine 4 to the inlet of the compressor 2 can be used as the outlet temperature To of the positive displacement fluid machine 4.

On the other hand, assuming that the positive displacement fluid machine 4 surely is activated, the activation of the positive displacement fluid machine 4 may be detected by the method described below. The method described below determines whether the positive displacement fluid machine 4 is in a state where the positive displacement fluid machine 4 can continue its operation, rather than recognize the activation of the positive displacement fluid machine 4. The method described below makes it possible to detect the activation of the positive displacement fluid machine 4 and close the bypass valve 8 in accordance with the result of the detection. Thereby, the positive displacement fluid machine 4 continues its operation stably even after the bypass valve 8 is closed.

Specifically, in the case where the temperature detector is used as the activation detector 104, a threshold value T₁ calculated experimentally or theoretically is set in the controller 102 in advance, for example. When the temperature difference ΔT detected by the temperature detector exceeds the threshold value T₁, the activation of the positive displacement fluid machine 4 is detected.

In the case where the pressure detector is used as the activation detector 104, a threshold value P₁ calculated experimentally or theoretically is set in the controller 102 in advance, for example. When the pressure difference ΔP detected by the pressure detector exceeds the specified threshold value P₁, the activation of the positive displacement fluid machine 4 is detected.

The following is the reason why the activation of the positive displacement fluid machine 4 can be detected by the comparison between the temperature difference ΔT and the threshold value T₁ or the comparison between the pressure difference ΔP and the threshold value P₁. When the compressor 2 is activated, the refrigerant discharged from the compressor 2 is supplied to the injection flow passage 10f through the bypass flow passage 10g. Thereby, the positive displacement fluid machine 4 is activated. The positive displacement fluid machine 4 starts rotating before a large temperature difference is made between a suction temperature of the compressor 2 and a discharge temperature of the compressor 2. At the time when the positive displacement fluid machine 4 starts rotating, the pressure difference in the refrigeration cycle has not yet been sufficiently large, and thus the power to rotate the positive displacement fluid machine 4 is small. Accordingly, the rotation speed of the positive displacement fluid machine 4 also is low. Even if the high pressure refrigerant continues being supplied to the injection port 30, the discharge of the refrigerant from the discharge port 27 is restricted by the rotation of the second piston 14. This state corresponds to a “narrow state” in terms of the expansion valve. Thus, the discharge temperature and the discharge pressure of the compressor 2 also increase gradually. As the discharge temperature and the discharge pressure of the compressor 2 increase, the rotation speed of the positive displacement fluid machine 4 also increases. Thereby, the pressure difference ΔP and the temperature difference ΔT also increase.

In the case where the timer is used as the activation detector 104, a threshold time t₁ calculated experimentally or theoretically is set in the controller 102 in advance, for example. When a time t measured by the timer exceeds the threshold time t₁, the activation of the positive displacement fluid machine 4 is detected.

The “threshold time t₁” is written in an activation control program to be executed by the controller 102. For example, the time from when the compressor 2 is activated to when the positive displacement fluid machine 4 is activated is actually measured under various operational conditions (such as outdoor air temperature). Then, a time in which the positive displacement fluid machine 4 is considered to be surely activated under all of the operational conditions can be set as the “threshold time t₁”. Theoretically, a model of the refrigeration cycle apparatus 100 is constructed, and a time that is necessary and sufficient to activate the positive displacement fluid machine 4 is calculated. The calculated time can be set as the “threshold time t₁”.

The method for detecting the activation of the positive displacement fluid machine 4 is not limited to one method, and a plurality of methods can be used in combination. For example, the activation of the positive displacement fluid machine 4 is recognized accurately by a method of monitoring the outlet pressure Po and/or the outlet temperature To of the positive displacement fluid machine 4. Thereafter, it is determined whether the positive displacement fluid machine 4 is in a state where the positive displacement fluid machine 4 can continue its operation, by the method of comparing the temperature difference ΔT with the threshold value T₁, the method of comparing the pressure difference ΔP with the threshold value P₁ or the method of comparing the elapsed time t with the threshold time t₁. When these conditions are satisfied, it is determined that the positive displacement fluid machine 4 is activated, so that the bypass valve 8 is closed and the expansion valve 6 is opened.

(Modification)

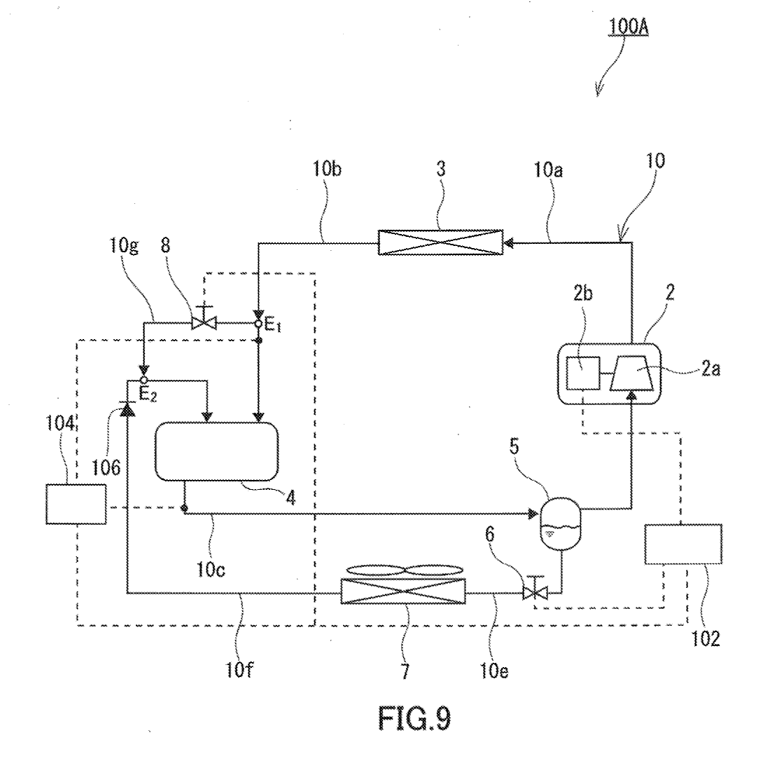

As shown in FIG. 9, a refrigeration cycle apparatus 100A according to the present modification includes a check valve 106 in addition to the components of the refrigeration cycle apparatus 100 described with reference to FIG. 1. The check valve 106 is provided on the injection flow passage 10f. Specifically, the check valve 106 is located on a side closer to the evaporator 7 when viewed from the downstream end E₂ (a junction between the bypass flow passage 10g and the injection flow passage 10f) of the bypass flow passage 10g. In the case where the check valve 106 is provided, opening the expansion valve 6 allows the compressor 2 to draw also the refrigerant in the evaporator 7. Therefore, it is possible to increase rapidly the discharge pressure of the compressor 2 at time of activation of the refrigeration cycle apparatus 100,

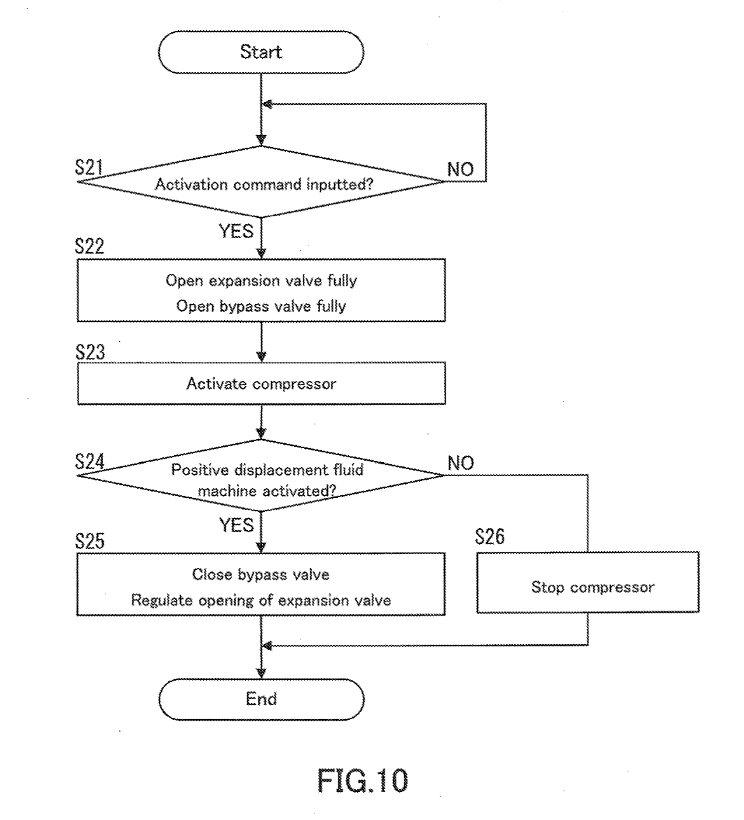

FIG. 10 is a flow chart illustrating the activation control of the refrigeration cycle apparatus according to the modification. The flow chart in FIG. 10 is different from the flow chart in FIG. 8 in that the expansion valve 6 is opened fully in Step S22, which is in Step S12 in FIG. 8. Since the check valve 106 is provided in the present modification, the expansion valve 6 is permitted to be opened before the positive displacement fluid machine 4 is activated. The other Steps S21, S23, S24, S25 and S26 respectively are the same as Steps S11, S13, S14, S15 and S16 described with reference to FIG. 8. It is preferable to activate the compressor 2 in Step S23 and then activate the fan or the pump of the evaporator 7 because the gas refrigerant to be drawn into the compressor 2 is generated effectively.

### Embodiment 2

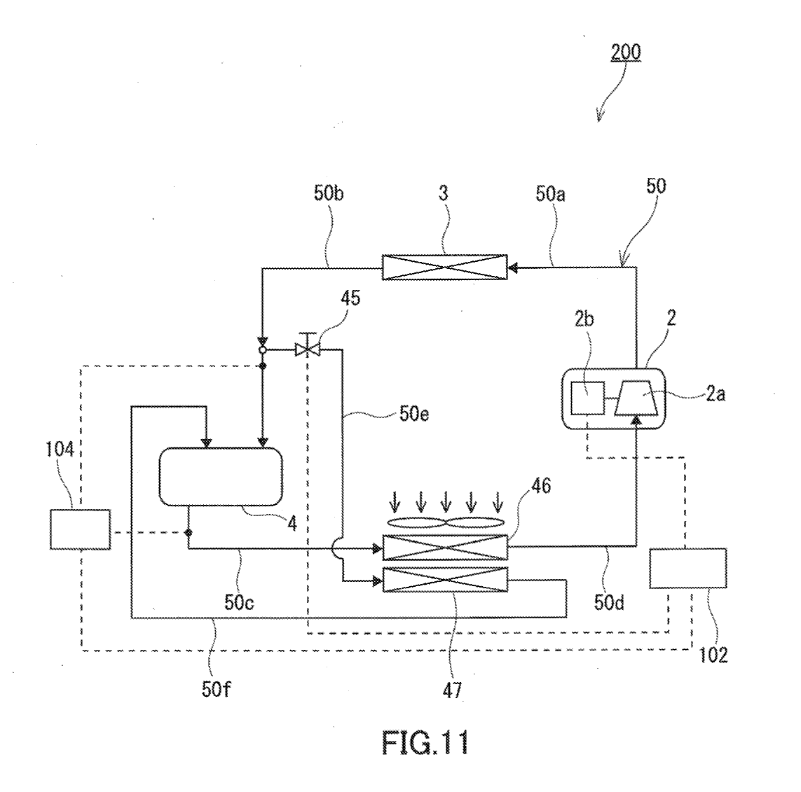

FIG. 11 is a configuration diagram of a refrigeration cycle apparatus according to Embodiment 2 of the present invention. The refrigeration cycle apparatus 200 includes the compressor 2, the radiator 3, the positive displacement fluid machine 4, an expansion valve 45, a first evaporator 46 and a second evaporator 47. These components are connected to each other by flow passages 50a to 50f so as to form a refrigerant circuit 50.

The compressor 2, the radiator 3, the positive displacement fluid machine 4, the controller 102 and the activation detector 104 are the same as in Embodiment 1, as can be understood from the fact that they are indicated by the same reference numerals as those in Embodiment 1, respectively. However, the present embodiment is different from Embodiment 1 regarding the control to be executed by the controller 102. The expansion valve 45 is a valve with a variable opening, such as an electric expansion valve. The first evaporator 46 and the second evaporator 47 each are a device for providing heat to the refrigerant, and typically is composed of an air-refrigerant heat exchanger.

The flow passage 50a connects the compressor 2 to the radiator 3 so that the refrigerant compressed in the compressor 2 is supplied to the radiator 3. The flow passage 50b connects the radiator 3 to the positive displacement fluid machine 4 so that a part of the refrigerant that has flowed out of the radiator 3 is supplied to the positive displacement fluid machine 4. The flow passage 50c connects the positive displacement fluid machine 4 to the first evaporator 46 so that the refrigerant discharged from the positive displacement fluid machine 4 is supplied to the first evaporator 46. The flow passage 50d connects the first evaporator 46 to the compressor 2 so that the refrigerant that has flowed out of the first evaporator 46 is supplied to the compressor 2. The flow passage 50e connects the radiator 3 to the second evaporator 47 so that a part of the refrigerant that has flowed out of the radiator 3 is supplied to the second evaporator 47. Specifically, the flow passage 50e is a flow passage (branch flow passage) branched from the flow passage 50b, and has an upstream end connected to the flow passage 50b between the radiator 3 and the positive displacement fluid machine 4 and a downstream end connected to the second evaporator 47. The expansion valve 45 is disposed on the flow passage 50e. The refrigerant is decompressed by the expansion valve 45 and then flows into the second evaporator 47. The flow passage 50f (injection flow passage) connects the second evaporator 47 to the positive displacement fluid machine 4 so that the gas refrigerant that has flowed out of the second evaporator 47 is supplied (injected) to the positive displacement fluid machine 4.

The first evaporator 46 and the second evaporator 47 are disposed on a flow passage for a heat medium (air, for example) so that the heat medium cooled in the first evaporator 46 is cooled further in the second evaporator 47. The direction indicated by the arrows in FIG. 11 is the flowing direction of the heat medium. The temperature of the refrigerant in the first evaporator 46 is higher than that of the refrigerant in the second evaporator 47. Thus, as shown in FIG. 11, in the case where the first evaporator 46 and the second evaporator 47 are disposed respectively on an upstream and a downstream of the flow passage for the heat medium, it is almost like the heat medium (air) and the refrigerant form mutually opposed flows. Thereby, the efficiency of the heat exchange between the refrigerant and the heat medium in the evaporators 46 and 47 is enhanced. Moreover, since the pressure of the refrigerant that has flowed out of the second evaporator 47 is increased in the positive displacement fluid machine 4, the COP of the refrigeration cycle apparatus 200 is enhanced as in Embodiment 1.

The compressor 2 draws the refrigerant and compresses the drawn refrigerant. The compressed refrigerant is cooled in the radiator 3 while remaining at a high pressure. The cooled refrigerant flows into the two flow passages 50b and 50e. A part of the cooled refrigerant is drawn into the positive displacement fluid machine 4 through the flow passage 50b. The refrigerant drawn into the positive displacement fluid machine 4 is decompressed to an intermediate pressure in the positive displacement fluid machine 4 to be turned into a gas-liquid two phase. The refrigerant discharged from the positive displacement fluid machine 4 flows into the first evaporator 46 through the flow passage 50c. The refrigerant that has flowed into the first evaporator 46 is heated in the first evaporator 46, and then drawn into the compressor 2 through the flow passage 50d. On the other hand, the remainder of the refrigerant cooled in the radiator 3 is decompressed by the expansion valve 45 to be turned into a gas-liquid two phase, and then supplied to the second evaporator 47 through the flow passage 50e. The refrigerant that has flowed into the second evaporator 47 is heated in the second evaporator 47, and then supplied (injected) to the positive displacement fluid machine 4 through the injection flow passage 50f.

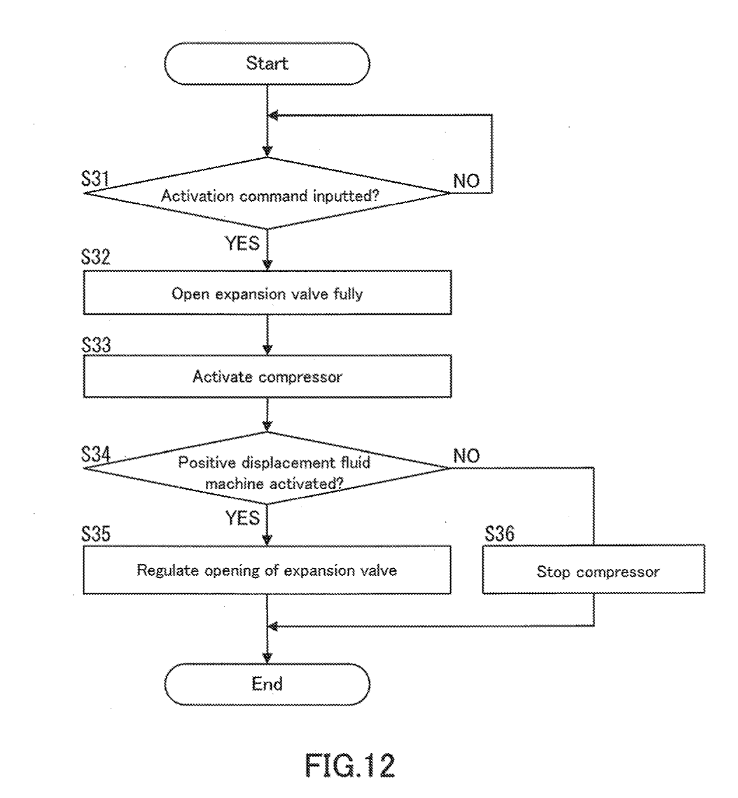

The activation control to be executed at time of activation of the refrigeration cycle apparatus 200 is described. FIG. 12 is a flow chart illustrating the activation control of the refrigeration cycle apparatus in the present embodiment. Steps S31, S33, S34 and S36 in the flow chart in FIG. 12 respectively are the same as Step S11, S13, S14 and S16 in the flow chart in FIG. 8.

After the activation command is inputted, the expansion valve 45 (Step S32) is fully opened. When the compressor 2 is activated in Step S33, the pressures in the flow passage 50e, the second evaporator 47 and the injection flow passage 50f are increased. The pressure in the second suction space 17a of the positive displacement fluid machine 4 also is increased through the injection port 30. The increased pressure in the second suction space 17a increases the torque for rotating the shaft 15. As a result, the positive displacement fluid machine 4 can be self-activated easily. After the positive displacement fluid machine 4 is activated, the opening of the expansion valve 45 is regulated (Step S35). Preferably, the opening of the expansion valve 6 is decreased stepwise (gradually) when the control method of the refrigeration cycle apparatus 200 is switched from the activation control to the normal control. Thereby, the change in load when the recompression process is performed in the positive displacement fluid machine 4 is lessened. As described above, also in the present embodiment, the controller 102 executes control of the expansion valve 45 as the activation control in order to allow the pressure in the injection flow passage 50f to be a pressure equal to the outlet pressure of the compressor 2.

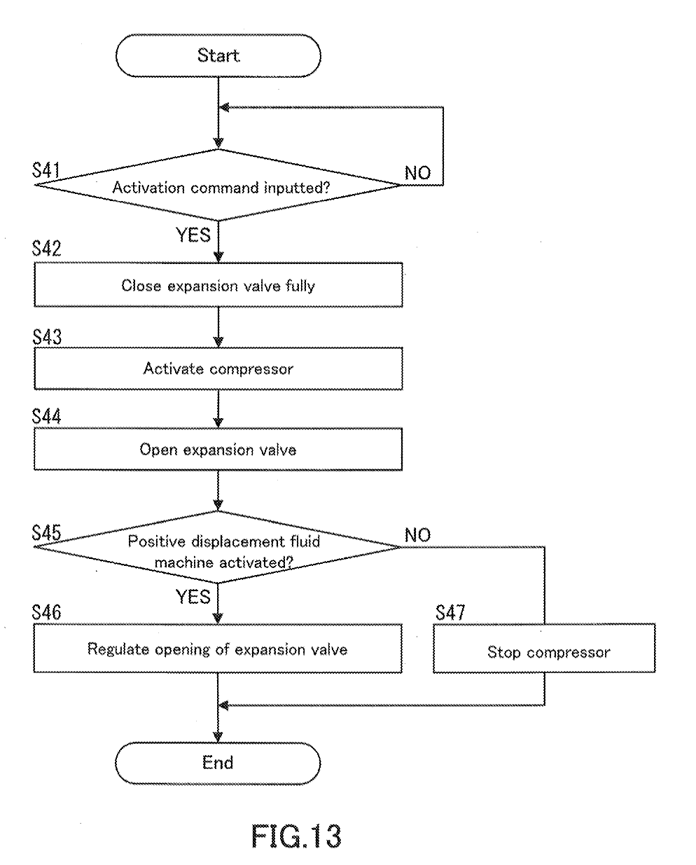

The activation control shown in FIG. 13 may be performed in the refrigeration cycle apparatus 200. The activation control shown in FIG. 13 includes a process of activating the compressor 2 in a state where the expansion valve 45 is fully closed (Step S42), and a process of opening fully the expansion valve 45 after the compressor 2 is activated (Step S44). Steps S41, S45, S46 and S47 in the flow chart in FIG. 13 respectively are the same as Steps S31, S34, S35 and S36 in the flow chart in FIG. 12.

After the activation command is inputted, the expansion valve 45 is fully closed (Step S42). Subsequently, the compressor 2 is activated (Step S43). After the compressor 2 is activated, the expansion valve 45 is opened when a certain time elapses or when the inlet pressure Pi of the positive displacement fluid machine 4 reaches a certain pressure (Step S44). As a result, the pressures in the flow passage 50e, the second evaporator 47 and the injection flow passage 50f are increased abruptly. That is, it is possible to generate instantaneously a pressure necessary to activate the positive displacement fluid machine 4. Thus, the positive displacement fluid machine 4 can be activated at once in a state where the lubricating oil is retained between sliding parts (between the piston and the cylinder, for example) of the positive displacement fluid machine 4. Therefore, it is possible to prevent occurrence of a situation in which the lubricating oil present between the sliding parts of the positive displacement fluid machine 4 is swept away by the refrigerant and the sliding parts are brought into solid contact with each other to raise the coefficient of static friction therebetween.

(Modification)

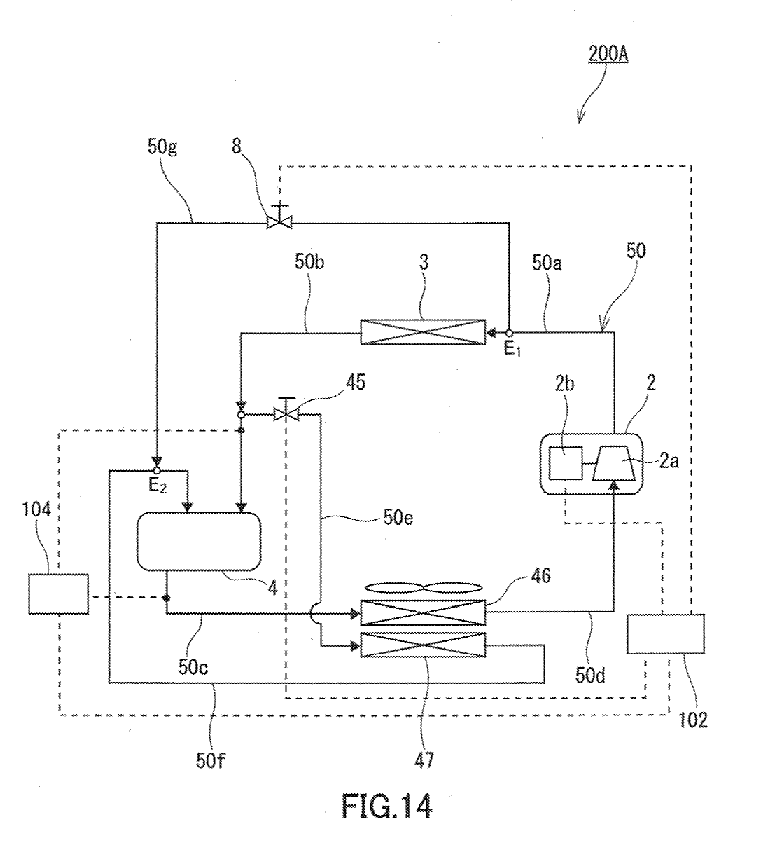

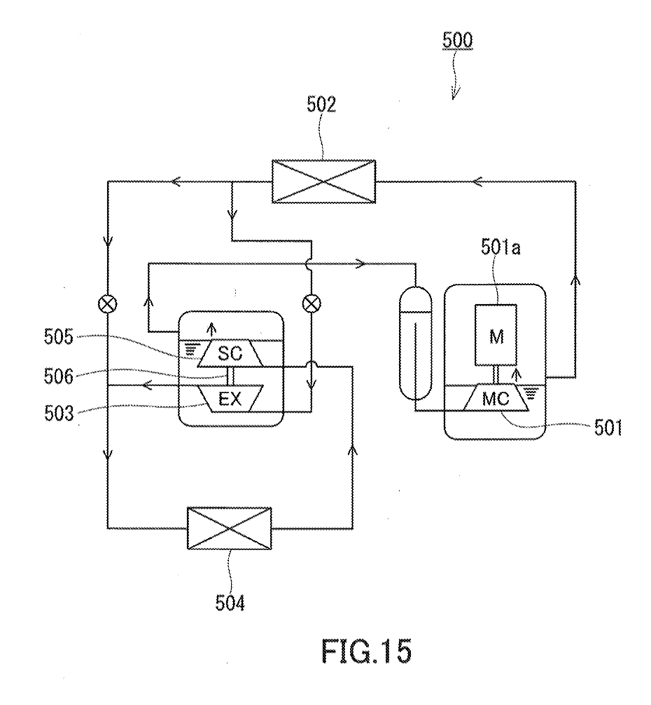

As shown in FIG. 14, a refrigeration cycle apparatus 200A according to the present modification includes a bypass flow passage 50g and the bypass valve 8 in addition to the components of the refrigeration cycle apparatus 200 described with reference to FIG. 11. The bypass flow passage 50g and the bypass valve 8 respectively have the same functions as those of the bypass flow passage 10g and the bypass valve 8 described in Embodiment 1. That is, it is possible to supply directly the discharge pressure of the compressor 2 to the injection flow passage 50f by closing the expansion valve 45 and opening the bypass valve 8.

The following effects are obtained when the refrigerant compressed in the compressor 2 is supplied to the second suction space 17a of the positive displacement fluid machine 4 through the bypass flow passage 50g, the injection flow passage 50f and the injection port 30. That is, by supplying the high temperature refrigerant to the second suction space 17a, it is possible to heat the lubricating oil filling a space between the sliding parts. The heating reduces the viscosity of the lubricating oil and lowers the coefficient of static friction between the sliding parts. This contributes to more smooth activation of the positive displacement fluid machine 4.

### Other Embodiments

The bypass valve 8 used in the refrigeration cycle apparatus 100 shown in FIG. 1, the refrigeration cycle apparatus 100A shown in FIG. 9 and the refrigeration cycle apparatus 200A shown in FIG. 14 is not limited to the on-off valve. The bypass valve 8 may be, for example, a three-way valve provided on the downstream end E₂ of the bypass flow passage 10g or 50g.

Although the two-stage rotary positive displacement fluid machine 4 is described in detail in this description, the present invention can be applied also to a refrigeration cycle apparatus in which a positive displacement fluid machine with another structure, such as a single-stage rotary positive displacement fluid machine, is used. Furthermore, the type of the positive displacement fluid machine is not limited to the rotary type. By adopting an injection port provided with a check valve and a discharge port provided with a discharge valve, it is possible to obtain the same functions as those of the positive displacement fluid machine 4 described in this description.

### INDUSTRIAL APPLICABILITY

The refrigeration cycle apparatus of the present invention can be used in a hot water supply appliance, a hot water heater, an air conditioner and the like.

1. A refrigeration cycle apparatus comprising:
a compressor for compressing a refrigerant;
a radiator for cooling the refrigerant compressed in the compressor;
a positive displacement fluid machine having a working chamber and an injection port, and configured to perform (i) a step of drawing, at a first pressure, the refrigerant cooled in the radiator into the working chamber, (ii) a step of, in the working chamber, expanding the drawn refrigerant to a second pressure lower than the first pressure and overexpanding further the refrigerant to a third pressure lower than the second pressure, (iii) a step of supplying, through the injection port, the refrigerant having the third pressure to the working chamber so as to mix the supplied refrigerant with the overexpanded refrigerant, (iv) a step of recompressing, in the working chamber, the mixed refrigerant to the second pressure by using power recovered from the refrigerant in the step (ii), and (v) a step of discharging the recompressed refrigerant from the working chamber;
an evaporator for heating the refrigerant discharged from the positive displacement fluid machine;
an injection flow passage through which the refrigerant having the third pressure is supplied to the injection port of the positive displacement fluid machine; and
a controller configured to execute an activation control for allowing a pressure in the injection flow passage to be a pressure equal to an outlet pressure of the compressor, instead of the third pressure, at time of activation of the refrigeration cycle apparatus.

2. The refrigeration cycle apparatus according to claim 1, further comprising:
a high pressure flow passage connecting the compressor, the radiator and the positive displacement fluid machine in this order so that the refrigerant discharged from the compressor is supplied to the radiator and the refrigerant that has flowed out of the radiator is supplied to the positive displacement fluid machine;
a bypass flow passage for connecting the high pressure flow passage to the injection flow passage; and
a bypass valve provided on the bypass flow passage,
wherein the controller executes control of the bypass valve as the activation control.

3. The refrigeration cycle apparatus according to claim 1, further comprising:
a gas-liquid separator for separating the refrigerant discharged from the positive displacement fluid machine into a gas refrigerant and a liquid refrigerant;
a flow passage connecting the gas-liquid separator to the compressor so that the gas refrigerant separated out in the gas-liquid separator is supplied to the compressor;
a flow passage connecting the gas-liquid separator to the evaporator so that the liquid refrigerant separated out in the gas-liquid separator is supplied to the evaporator; and
an expansion valve provided on the flow passage connecting the gas-liquid separator to the evaporator,
wherein the injection flow passage connects the evaporator to the positive displacement fluid machine.

4. The refrigeration cycle apparatus according to claim 3, wherein the controller executes control of the expansion valve as the activation control.

5. The refrigeration cycle apparatus according to claim 3, further comprising a check valve that is provided on the injection flow passage and located on a side closer to the evaporator when viewed from a junction between the bypass flow passage and the injection flow passage.

6. The refrigeration cycle apparatus according to claim 1, further comprising:
a flow passage connecting the radiator to the positive displacement fluid machine so that the refrigerant that has flowed out of the radiator is supplied to the positive displacement fluid machine;
a branch flow passage having an upstream end connected to the flow passage between the radiator and the positive displacement fluid machine;
an expansion valve provided on the branch flow passage; and
a second evaporator to which a downstream end of the branch flow passage is connected,
wherein the injection flow passage connects the second evaporator to the positive displacement fluid machine.

7. The refrigeration cycle apparatus according to claim 6, wherein
assuming that the evaporator for heating the refrigerant discharged from the positive displacement fluid machine is a first evaporator,
the refrigeration cycle apparatus further comprises a flow passage, the flow passage connecting the first evaporator to the compressor so that the refrigerant heated in the first evaporator is supplied to the compressor, and
the first evaporator and the second evaporator are disposed respectively on an upstream and a downstream of a flow passage for a heat medium so that the heat medium that has heated the refrigerant in the first evaporator flows into the second evaporator.

8. The refrigeration cycle apparatus according to claim 6, wherein the controller executes control of the expansion valve as the activation control.

9. The refrigeration cycle apparatus according to claim 6, wherein the activation control includes a process of activating the compressor in a state where the expansion valve is fully closed, and a process of opening fully the expansion valve after the compressor is activated.

10. The refrigeration cycle apparatus according to claim 8, wherein the controller decreases stepwise an opening of the expansion valve after the positive displacement fluid machine is activated.

11. The refrigeration cycle apparatus according to claim 1, further comprising an activation detector for detecting the activation of the positive displacement fluid machine,
wherein the controller switches a control method of the refrigeration cycle apparatus from the activation control to a normal control, based on a result of detection by the activation detector.

12. The refrigeration cycle apparatus according to claim 11, wherein
the activation detector includes a timer for measuring time elapsed from a time point of activation of the compressor, and
when the time measured by the timer exceeds a specified threshold time, the activation of the positive displacement fluid machine is detected.

13. The refrigeration cycle apparatus according to claim 11, wherein
the activation detector includes a temperature detector for detecting a difference between an inlet temperature of the positive displacement fluid machine and an outlet temperature of the positive displacement fluid machine, and
when the temperature difference detected by the temperature detector exceeds a specified threshold value, the activation of the positive displacement fluid machine is detected.

14. The refrigeration cycle apparatus according to claim 11, wherein
the activation detector includes a pressure detector for detecting a difference between an inlet pressure of the positive displacement fluid machine and an outlet pressure of the positive displacement fluid machine, and
when the pressure difference detected by the pressure detector exceeds a specified threshold value, the activation of the positive displacement fluid machine is detected.

15. The refrigeration cycle apparatus according to claim 11, wherein
the activation detector includes a temperature detector for detecting a temperature in a flow passage from an outlet of the positive displacement fluid machine to an inlet of the compressor, and
when a value obtained by subtracting a temperature detected by the temperature detector at a time point before a unit time from a current temperature detected by the temperature detector exceeds a specified threshold value, the activation of the positive displacement fluid machine is detected.

16. The refrigeration cycle apparatus according to claim 11, wherein
the activation detector includes a pressure detector for detecting a pressure in a flow passage from an outlet of the positive displacement fluid machine to an inlet of the compressor, and
when a value obtained by subtracting a pressure detected by the pressure detector at a time point before a unit time from a current pressure detected by the pressure detector exceeds a specified threshold value, the activation of the positive displacement fluid machine is detected.

17. The refrigeration cycle apparatus according to claim 11, wherein when the positive displacement fluid machine fails to be activated, the controller stops the compressor.

18. The refrigeration cycle apparatus according to claim 1, wherein
the positive displacement fluid machine has:
a first cylinder;
a first piston disposed inside the first cylinder so as to form a first space between itself and the first cylinder;
a first vane partitioning the first space into a first suction space and a first discharge space;
a second cylinder disposed concentrically with respect to the first cylinder;
a second piston disposed inside the second cylinder so as to form, between itself and the second cylinder, a second space having a larger volumetric capacity than that of the first space;
a second vane partitioning the second space into a second suction space and a second discharge space;
an intermediate plate disposed between the first cylinder and the second cylinder;
a communication flow passage provided in the intermediate plate so as to bring the first discharge space into communication with the second suction space;
a suction port through which the refrigerant is drawn into the first suction space; and
a discharge port through which the refrigerant is discharged from the second discharge space, and
the working chamber is formed of the first space, the second space and the communication flow passage, and
the injection port is provided at a position that allows the refrigerant to be supplied to the second suction space through the injection port.
